(19) United States
(12) Patent Application Publication
(10) Pub. No.: US 2010/0250058 A1
(43) Pub. Date: Sep. 30, 2010

(54) SYSTEMS AND METHOD FOR PROTECTED MEMORY

(76) Inventor: Joseph Bernard Steffler, Alto, MI (US)

Correspondence Address: JOHN S. BEULICK (12729);C/O ARMSTRONG TEASDALE LLP, 7700 FORSYTH BOULEVARD, SUITE 1800, ST. LOUIS, MO, 63105, US

(21) Appl. No.: 12/415,246

(22) Filed: Mar. 31, 2009

(51) Int. Cl. G06F 19/00; H04B 1/00

(52) U.S. Cl. 701/35; 375/256

(57) ABSTRACT

Systems and a method for a crash protected memory (CPM) are provided. The CPM includes a housing that includes a wall wherein at least a portion of the wall is at least partially transparent to radio frequency (RF) radiation. The housing includes an interior cavity sealable from an exterior of the housing. The CPM also includes a receiver positioned within the interior of the housing. The receiver is configured to communicatively couple to a transmitter through the at least a portion of the wall. The CPM further includes a memory for storing data related to the operation of a vehicle communicatively coupled to the receiver.

### BACKGROUND OF THE INVENTION

The field of this invention relates generally to crash protected memories (CPM) and, more particularly, to systems and a method for storing data to a CPM.

Modern crash recorders are required to record vehicle operation and performance data as well as multiple cabin audio and video sources. With the increasing quantity and bandwidth of data and signal sources, the data bandwidth to and from the CPM portion of the crash recorder continues to increase. Additionally, crash survivability requirements dictate that the number of electrical signal paths in and out of the CPM be kept to a minimum in order to reduce the effects of high-temperature fires often associated with crash events on the electronic devices within the CPM.

Current CPMs utilize proprietary electrical interfaces that use twelve or more conductors. The number of electrical conductors that penetrate the housing of the CPM conducts excessive heat from a fire often associated with an off-normal event, such as a crash event. The excessive heat is transmitted into the circuitry inside the CPM, which poses a risk to the data stored within.

### BRIEF DESCRIPTION OF THE INVENTION

In one embodiment, a crash protected memory (CPM) includes a housing that includes a wall wherein at least a portion of the wall is at least partially transparent to radio frequency (RF) radiation. The housing includes an interior cavity sealable from an exterior of the housing. The CPM also includes a receiver positioned within the interior of the housing. The receiver is configured to communicatively couple to a transmitter through the at least a portion of the wall. The CPM further includes a memory for storing data related to the operation of a vehicle communicatively coupled to the receiver.

In another embodiment, a method for transmitting data to a protected memory system enclosed in a sealed housing includes positioning a receiver in an interior cavity of the housing, positioning a transmitter proximate an exterior of the housing, and transmitting at least one of data signals and electrical power from the transmitter to the receiver through the housing

In yet another embodiment, a flight data recorder includes a data acquisition unit configured to receive a plurality of data signals related to the operation of a vehicle and a CPM system. The CPM includes a housing that includes a wall wherein at least a portion of the wall is substantially transparent to radio frequency (RF) radiation. The housing includes an interior cavity sealable from an exterior of the housing. The flight data recorder also includes a receiver positioned within the interior of the housing that is configured to communicatively couple to a transmitter through the at least a portion of the wall. The flight data recorder further includes a memory device communicatively coupled to the receiver, the memory device configured to store the plurality of data signals received through the receiver.

### BRIEF DESCRIPTION OF THE DRAWINGS

FIGS. 1-2 show exemplary embodiments of the systems and method described herein.

FIG. 1 is a schematic block diagram of a flight data recorder in accordance with an exemplary embodiment of the present invention; and

FIG. 2 is a flow chart of a method for transmitting data to a protected memory system in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to systems and a method for preserving data stored on memory components from harsh environments in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

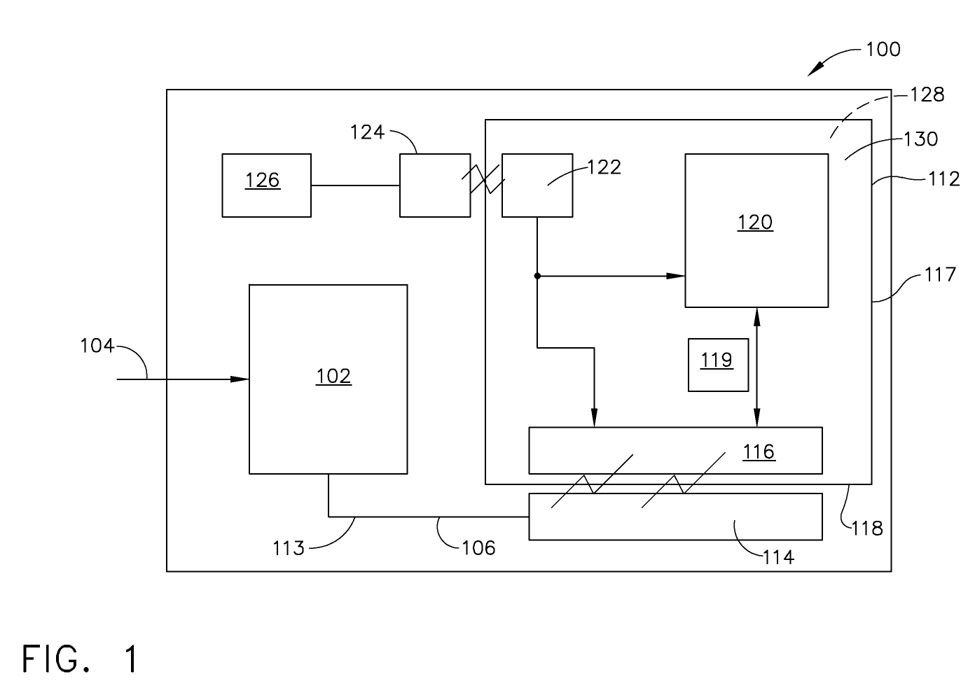

FIG. 1 is a schematic block diagram of a flight data recorder 100 in accordance with an exemplary embodiment of the present invention. In the exemplary embodiment, flight data recorder 100 includes a data acquisition unit 102 configured to receive a plurality of data signals 104 and to generate a series of data packets 106 for storage. Flight data recorder 100 includes a crash protected memory (CPM) 112 communicatively coupled to data acquisition unit 102 through a conduit 113 and a transmitter 114 and receiver 116 combination. Transmitter 114 and receiver 116 cooperate to communicate data packets 106 through a housing 117 of CPM 112 that includes at least one wall 118. In an alternative embodiment, transmitter 114 and receiver 116 are portions of respective transceivers that are configured to transmit data bi-directionally through wall 118. Transmitter 114 and receiver 116 may communicate using a standard protocol such as, but not limited to, Bluetooth, ZigBee, Ultra Wide Band (UWB), and Wireless USB. In the exemplary embodiment, CPM 112 includes a memory device 120 that is used to store data related to the operation of a vehicle (not shown). CPM 112 also includes a power receiver or secondary coil 122 configured to inductively couple to a power transmitter or primary coil 124 though wall 118. Primary coil 124 is positioned outside of wall 118 and secondary coil 122 is positioned opposite primary coil 124 inside wall 118 and is configured to provide electrical power for devices within cavity 128. Wall 118 may be substantially transparent to radio frequency (RF) and/or magnetic fields only at certain portions where secondary coil 122 and primary coil 124, and where transmitter 114 and receiver 116 are located. Alternatively, wall 118 may be substantially transparent to RF radiation and/or magnetic fields throughout CPM 112. Primary coil 124 is electrically coupled to a power source 126.

In one embodiment, CPM 112 is fabricated from a non-metallic material such as a ceramic material. In various embodiments, CPM 112 is fabricated from a metallic material that is at least partially transparent to RF radiation. For example, CPM 112 may be fabricated from a composite material comprising a metal and a non-metal material. By transmitting data signals and electrical power through wall 118 using transmitters external to CPM 112 and receivers positioned internal to CPM 112, wires and/or metallic conductors passing through wall 118 may be eliminated or significantly reduced in number. Having no wires that extend through housing wall 118, conduction paths for heat transmission into a cavity 128 of CPM 112 is minimized.

In one embodiment, housing 117 includes a removable wall or lid 130 that provides access to cavity 128. In various embodiments, lid 130 may be fabricated of a material different than the material of wall 118. For example, wall 118 may be fabricated from a metal or a composite and lid 130 may be fabricated from a ceramic material or vice versa. Wall 118 and lid 130 may also be fabricated from similar materials.

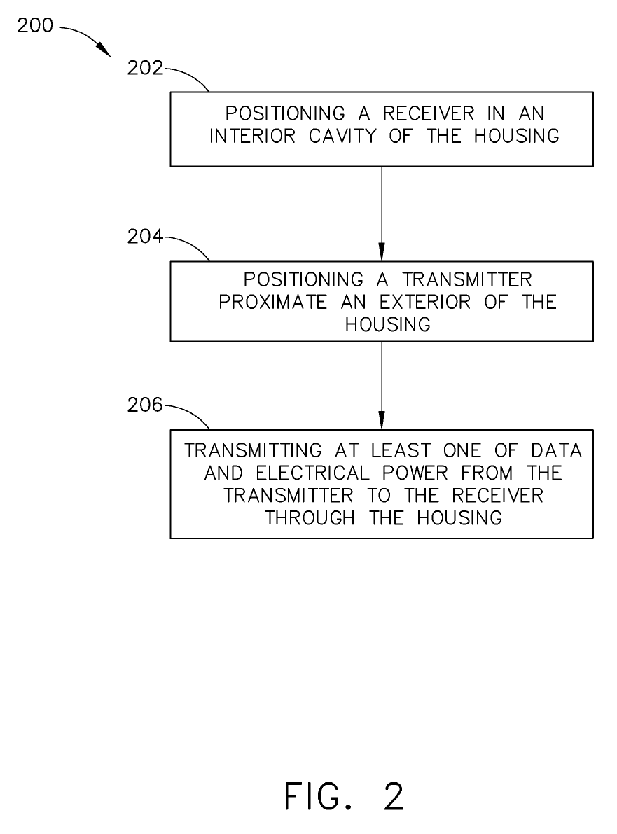

FIG. 2 is a flow chart of a method 200 for transmitting data to a protected memory system enclosed in a sealed housing. In the exemplary embodiment, method 200 includes positioning 202 a receiver in an interior cavity of the housing, positioning 204 a transmitter proximate an exterior of the housing, and transmitting 206 at least one of data and electrical power from the transmitter to the receiver through the housing.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor 119. Processor 119 may be used in CPM 112 or may be absent depending on the requirements of CPM 112.

As used herein, the term memory may include RAM memory, ROM memory, EPROM memory, EEPROM memory, and non-volatile RAM (NVRAM) memory. The above memory types are exemplary only, and are thus not limiting as to the types of memory usable with flight data recorder 100.

As will be appreciated based on the foregoing specification, the above-described embodiments of the disclosure may be implemented using computer programming or engineering techniques including computer software, firmware, hardware or any combination or subset thereof, wherein the technical effect is transmitting data signals and/or electrical power through an armor housing of a CPM wirelessly. Elimination of metal conductors penetrating the wall of the CPM housing reduces heat ingress into the cavity of the CPM where heat sensitive components are positioned. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of systems and a method for transmitting data to a protected memory system provides a cost-effective and reliable means for storing data on a CPM without providing a path for heat transmission through the wall of the CPM. More specifically, the systems and method described herein provide a unique application of a wireless data and power interface that enhances the survivability of the memory devices within the CPM during crashes involving fire, by eliminating the electrical conductors leading in and out of the CPM armor and the heat that is conducted therein. As a result, the systems and method described herein facilitate storing and subsequent recovery of data during an off-normal event and investigation in a cost-effective and reliable manner.

Exemplary systems and a method for transmitting data to a protected memory system are described above in detail. The systems illustrated are not limited to the specific embodiments described herein, but rather, components of each may be utilized independently and separately from other components described herein. Each system component can also be used in combination with other system components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A crash protected memory (CPM) system comprising:
a housing comprising a wall, at least a portion of said wall is at least partially transparent to radio frequency (RF) radiation, said housing comprising an interior cavity sealable from an exterior of said housing;
a receiver positioned within the interior of said housing, said receiver configured to communicatively couple to a transmitter through said at least a portion of said wall; and
a memory for storing data related to the operation of a vehicle communicatively coupled to said receiver.

2. A crash protected memory system in accordance with claim 1, wherein no wires extend through said housing wall.

3. A crash protected memory system in accordance with claim 1, wherein said housing comprises a ceramic material.

4. A crash protected memory system in accordance with claim 1, wherein said housing comprises a removable wall that provides access to said cavity.

5. A crash protected memory system in accordance with claim 4, wherein said removable wall comprises a ceramic material.

6. A crash protected memory system in accordance with claim 1, further comprising a transmitter positioned at the exterior of said housing.

7. A crash protected memory system in accordance with claim 1, wherein said receiver is configured to receive at least one of data signals and electrical power through said portion of said wall.

8. A crash protected memory system in accordance with claim 1, wherein said receiver is configured to receive data in a format comprising at least one of Bluetooth, ZigBee, Ultra Wide Band (UWB), and Wireless USB.

9. A crash protected memory system in accordance with claim 1, wherein said receiver comprises an inductive coil positioned within the cavity, said inductive coil configured to provide electrical power for devices within the cavity.

10. A crash protected memory system in accordance with claim 1, wherein said memory is configured to store data related to the operation of a vehicle communicatively coupled to said receiver.

11. A crash protected memory system in accordance with claim 1, wherein said receiver is a receiver portion of a transceiver, said transceiver further configured to transmit data to a receiver positioned external to the housing.

12. A method for transmitting data to a protected memory system enclosed in a sealed housing, said method comprising:
positioning a receiver in an interior cavity of the housing;
positioning a transmitter proximate an exterior of the housing; and
transmitting at least one of data and electrical power from the transmitter to the receiver through the housing.

13. A method in accordance with claim 12, further comprising communicatively coupling the receiver to a memory device.

14. A method in accordance with claim 12, wherein transmitting data from the transmitter to the receiver through the housing comprises transmitting data from the transmitter to the receiver through a portion of the housing that is substantially transparent to radio frequency (RF) radiation.

15. A method in accordance with claim 12, wherein transmitting data from the transmitter to the receiver through the housing comprises transmitting data from the transmitter to the receiver wirelessly.

16. A flight data recorder comprising:
a data acquisition unit configured to receive a plurality of data signals related to the operation of a vehicle; and
a crash protected memory (CPM) system comprising:
a housing comprising a wall, at least a portion of said wall is substantially transparent to radio frequency (RF) radiation, said housing comprising an interior cavity sealable from an exterior of said housing;
a receiver positioned within the interior of said housing, said receiver configured to communicatively couple to a transmitter through said at least a portion of said wall; and
a memory communicatively coupled to said receiver, said memory configured to store the plurality of data signals received through the receiver.

17. A flight data recorder in accordance with claim 16, wherein said housing comprises a ceramic material.

18. A flight data recorder in accordance with claim 16, wherein said receiver is configured to receive at least one of data signals and electrical power wirelessly through said portion of said wall.

19. A flight data recorder in accordance with claim 16, wherein said receiver comprises an inductive coil positioned within the cavity, said inductive coil configured to provide electrical power for devices within the cavity.

20. A flight data recorder in accordance with claim 16, wherein said receiver is a receiver portion of a transceiver, said transceiver further configured to transmit data to a receiver positioned external to the housing.
